(19) United States
(12) Patent Application Publication
(10) Pub. No.: US 2016/0047412 A1
(43) Pub. Date: Feb. 18, 2016

(54) ENHANCED THERMALLY CONDUCTIVE PIVOT BUSHING

(71) Applicant: The Boeing Company, Chicago, IL (US)

(72) Inventors: Christopher J. Stuk, Seattle, WA (US); William J. Koch, Bellevue, WA (US)

(73) Assignee: The Boeing Company, Chicago, IL (US)

(21) Appl. No.: 14/457,729

(22) Filed: Aug. 12, 2014

(51) Int. Cl. F16C 17/12; F16C 43/02; F16C 33/04; F16C 17/02

(52) U.S. Cl. CPC F16C 17/12; F16C 17/02; F16C 43/02; F16C 33/04; F16C 2202/20; F16C 2326/43

(57) ABSTRACT

An aircraft pivot joint bushing has enhanced thermal conductivity due to the bushing having an inner cylindrical portion which has a first thermal dissipating capacity, and an outer cylindrical portion on the inner cylindrical portion which has a second thermal dissipating capacity, where the second thermal dissipating capacity is less than the first thermal dissipating capacity.

### FIELD

This disclosure pertains to the construction of and the method of constructing an enhanced thermally conductive pivot bushing. More particularly, this disclosure pertains to an aircraft main landing gear pivot joint bushing having an increased heat sink material construction.

### BACKGROUND

Many transport category aircraft have truck beams on their main landing gear assemblies. In a typical landing gear assembly at least two pairs of wheels are attached to the fore and aft ends of the truck beam. A pivot pin connects an intermediate portion of the truck beam to an inner cylinder fork for pivoting movement of the truck beam relative to the fork. Cylindrical bushings are provided between the pivot pin and the truck beam and inner cylinder fork.

On take off and landing, as the aircraft rolls along a runway, the truck beam pitches in a fore and aft plane about the pivot pin. This pivoting movement generates localized friction heating at the interfaces of the moving parts. The amount of heating varies with factors such as runway roughness, joint friction, truck beam pitch velocity, and aircraft weight. The localized friction heating creates hot spots within the landing gear truck beam and the inner cylinder fork. If the generated friction heating reaches too high a level in the landing gear components, the metallic structure of the landing gear components can be adversely affected in various ways. This occurrence is generally referred to as “friction-induced heat damage.” The friction-induced heat damage can lead to fractures of the landing gear components where the damage occurs and possible loss of control of the aircraft.

Two basic approaches have been employed to resolve the problem of friction-induced heat damage of landing gear components. One has been to reduce frictional heating in the joint (e.g., improved lubrication systems, better greases, more frequent lubrication, active lubrication systems, use of polymer-lined bushings, metallic bushings with lower coefficients of friction, or use of truck beam-pitch dampers). The second has been to use structural components in the truck beam that are less susceptible to friction-induced heat damage (e.g., metal alloys).

However, these solutions have several drawbacks. Truck dampers and active lubrication systems are prone to failure and cannot be easily retrofitted to existing designs of landing gear assemblies. Improved greases and bushing materials often do not provide enough friction reduction to prevent heat damage. Polymer-lined bushings have not survived in extreme operating conditions. Increased lubrication frequency is burdensome and costly to aircraft maintenance programs. Special structural alloys are very expensive.

### SUMMARY

The enhanced thermally conductive pivot bushing of this disclosure overcomes the problem of localized friction-induced heat damage in landing gear components. The bushing distributes heat more equally to the landing gear components than previous solutions by increasing the thermal dissipating capacity of the bushing within the pivot joint, thus decreasing the amount of localized friction-induced heat transferred to the truck beam and the inner cylinder fork.

The aircraft pivot joint bushing has an inner cylindrical portion and an outer cylindrical portion. The inner cylindrical portion is constructed of a first material having a first thermal dissipating capacity. The first material also has a low coefficient of friction. The outer cylindrical portion is constructed of a second material having a second thermal dissipating capacity. The outer cylindrical portion engages around the inner cylindrical portion. The first material of the inner cylindrical portion is more thermally conductive than the second material of the outer cylindrical portion. Therefore, the inner cylindrical portion of the bearing has a more thermal dissipating capacity than the material of the outer cylindrical portion of the bearing.

In use, the inner cylindrical portion of the bearing is mounted inside the outer cylindrical portion, and the outer cylindrical portion of the bearing is mounted in pivot joint bores of the inner cylinder fork and the truck beam of the landing gear assembly.

Instead of reducing friction heat in the pivot joint or using different alloy materials in the truck beam or inner cylinder fork, the bushing simply adds a less thermally conductive material to the outer cylindrical portion of the bushing. Adding a less thermally conductive layer to the outer cylindrical portion of the bushing increases the thermal dissipating capacity of the inner cylindrical portion of the bushing. This construction forces heat in the inner cylindrical portion of the bushing to spread circumferentially through the inner cylindrical portion of the bushing before transferring radially to the outer cylindrical portion of the bushing. This distributes bushing heat more evenly and thus inhibits or prevents localized hot spots from forming on the landing gear truck beam and the inner cylinder fork connected to the pivot pin, thus inhibiting or preventing localized friction-induced heat damage to the truck beam and inner cylinder fork.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

Further features of the enhanced thermally conductive pivot bushing of this disclosure are set forth in the following detailed description and the drawing figures.

FIG. 1 is a representation of a perspective view of a landing gear assembly pivot pin, truck beam and inner cylinder fork employing the enhanced thermally conductive pivot bushing of this disclosure.

FIG. 2 is a representation of a cross section of the pivot pin, truck beam and inner cylinder fork of FIG. 1.

FIG. 3 is a representation of a perspective view of the pivot pin, truck beam and inner cylinder fork employing the enhanced thermally conductive pivot bushing that is similar to FIG. 1, but is from the opposite side of the landing gear assembly shown in FIG. 1.

FIG. 4 is a representation of a cross section of the pivot pin, truck beam and inner cylinder fork similar to FIG. 2, but from an opposite side of the landing gear assembly shown in FIG. 2.

FIG. 5 is a representation an elevation view of the cross sections of FIGS. 2 and 4.

FIG. 6 is a representation of a portion of FIG. 5 showing more detail of the enhanced thermally conductive pivot bushing.

FIG. 7 is a representation of an elevation view of a cross-section of a pivot bushing similar to that of FIG. 5, but showing a three layer pivot bushing.

FIG. 8 is a representation of a portion of FIG. 7 showing more detail of the enhanced thermally conductive pivot bushing.

### DETAILED DESCRIPTION

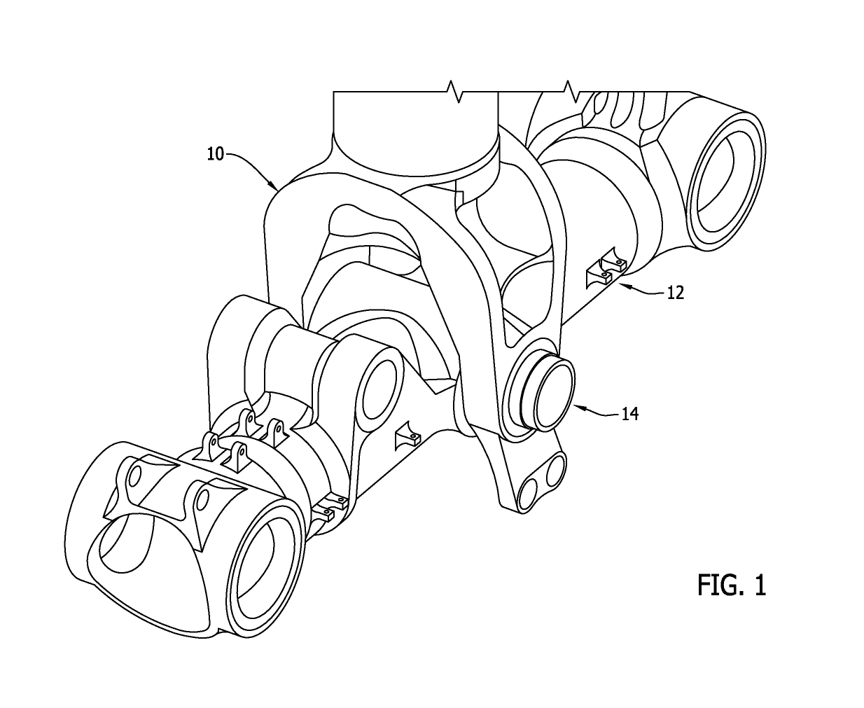

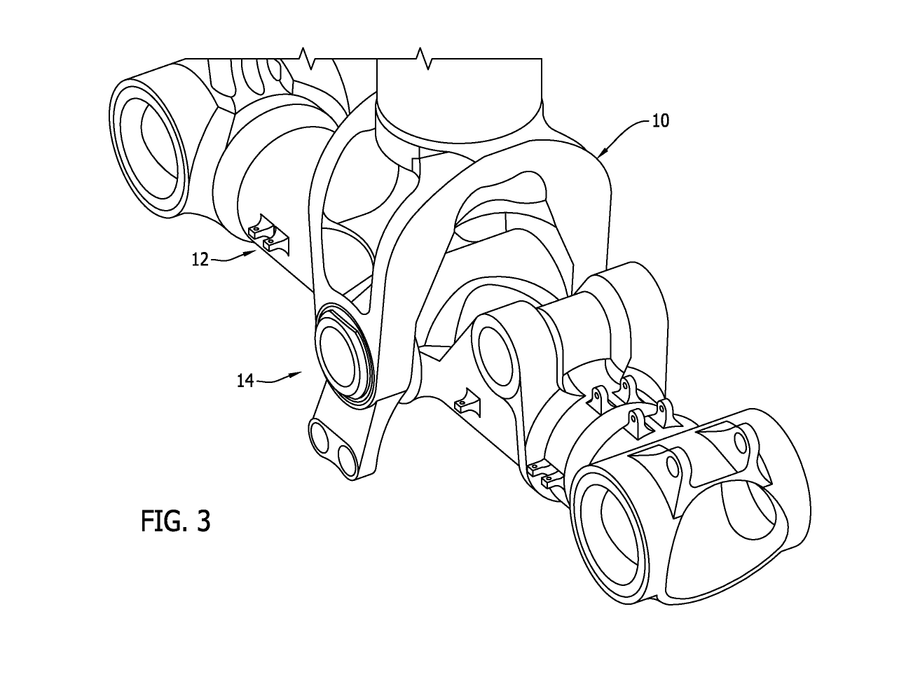

FIGS. 1 and 3 are partial views of the opposite right and left sides of a typical main landing gear assembly. The assembly includes an inner cylinder fork 10, a truck beam 12, and a pivot pin 14. As is conventional, the pivot pin 14 connects the truck beam 12 to the inner cylinder fork 10 for relative pivoting movement between the truck beam 12 and fork 10.

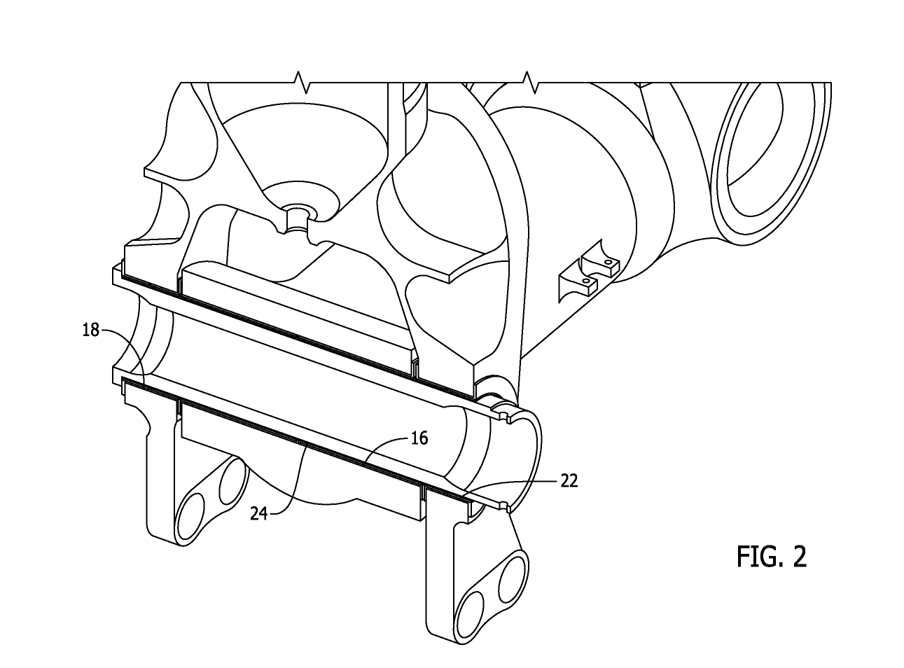

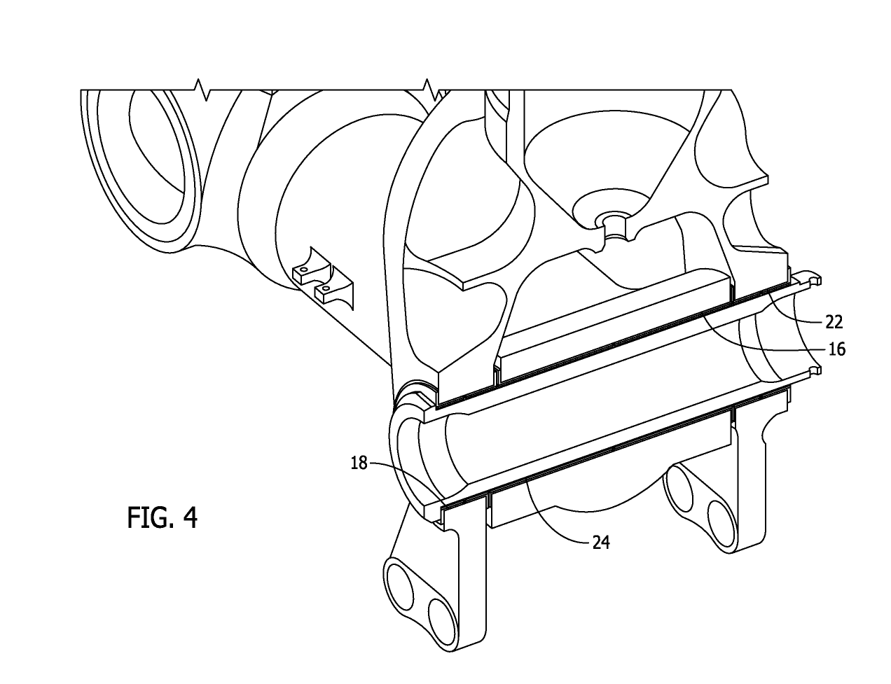

FIGS. 2 and 4 are cross section views of the pivot connection between the fork 10 and truck beam 12 represented in FIGS. 1 and 3, respectively.

Referring to FIGS. 2 and 4, the truck beam 12 is shown having a bore hole that extends through an intermediate portion of the truck beam 12. The bore hole is surrounded by a cylindrical interior surface 16.

The inner cylinder fork 10 has a pair of bore holes through the fork arms. The bore holes are surrounded by cylindrical interior surfaces 18, 22. The fork cylindrical interior surfaces 18, 22 are aligned with the truck beam cylindrical interior surface 16.

The pivot pin 14 has a cylindrical exterior surface 24 with a center axis 26. The pivot pin 14 is inserted through the aligned cylindrical interior surface 18 of the inner cylinder fork 10, the truck beam bore cylindrical interior surface 16 and the other inner cylinder fork cylindrical interior surface 22, completing the pivot connection between the inner cylinder fork 10 and the truck beam 12.

Also represented in FIGS. 2 and 4 are cross sections of six of the enhanced thermally conductive pivot bushings 32, 34, 36, 38, 42, 44 of this disclosure. Two of the bushings 32, 34 are in contact with the pivot pin exterior surface 24 and positioned inside the cylindrical interior surface 18 of the left side fork arm shown in FIGS. 2 and 4. Two of the bushings 36, 38 are in contact with the pivot pin exterior surface 24 and positioned inside the truck beam bore cylindrical interior surface 16. The remaining two bushings 42, 44 are in contact with the pivot pin exterior surface 24 and positioned inside the cylindrical interior surface 22 of the right side fork arm shown in FIGS. 2 and 4. Because the constructions of each of the six enhanced thermally conductive bushings 32, 34, 36, 38, 42, 44 are substantially the same, and because the three bushings 32, 34, 36 to the left in FIGS. 2 and 4 are mirror images of the three bushings 38, 42, 44 to the right in FIGS. 2 and 4, only the constructions of the three bushings 32, 34, 36 to the left will be further described herein.

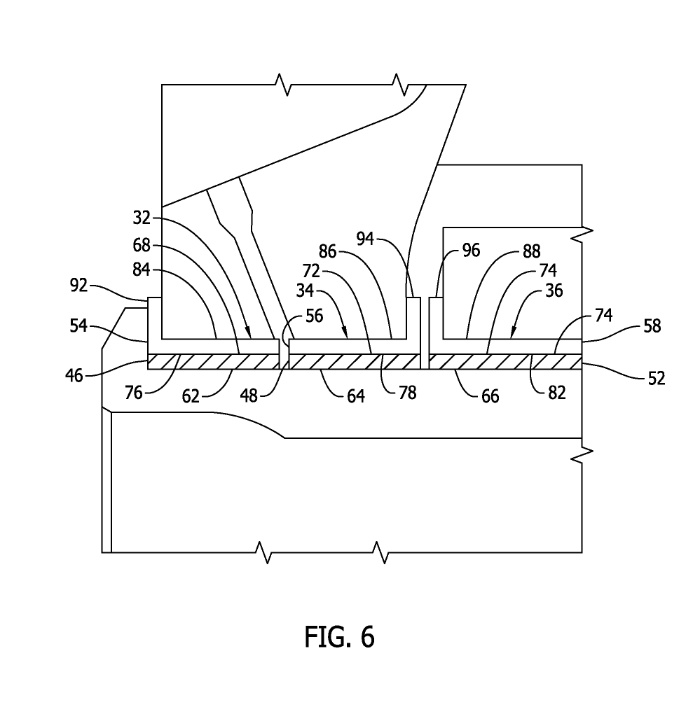

Referring to FIG. 6, each of the three bushings 32, 34, 36 is constructed with an inner cylindrical portion 46, 48, 52 and an outer cylindrical portion 54, 56, 58. The inner cylindrical portions 46, 48, 52 have respective cylindrical interior surfaces 62, 64, 66 and opposite cylindrical exterior surfaces 68, 72, 74. The outer cylindrical portions 54, 56, 58 have respective cylindrical interior surfaces 76, 78, 82 and opposite cylindrical exterior surfaces 84, 86, 88. The outer cylindrical portion interior surfaces 76, 78, 82 engage around the respective inner cylindrical portion exterior surfaces 68, 72, 74. The outer cylindrical portion exterior surfaces 84, 86 are press fit or shrunk fit inside the inner cylinder fork cylindrical interior surface 18. The outer cylindrical portion exterior surface 88 is press fit or shrunk fit inside the truck beam bore cylindrical interior surface 16. Each of the three bushings 32, 34, 36 has a respective annular flange 92, 94, 96 that extends radially outward from one axial end of the bushing outer cylindrical portion 54, 56, 58.

The inner cylindrical portions 46, 48, 52 and their respective outer cylindrical portions 54, 56, 58 could be separate cylinders with the outer cylindrical portions 54, 56, 58 press fit or shrunk fit over the respective inner cylindrical portions 46, 48, 52. Alternatively, the inner cylindrical portions 46, 48, 52 and their respective outer cylindrical portions 54, 56, 58 could be formed as monolithic cylinders with the materials of the concentric and coaxial cylinders being fused together where the inner cylindrical portion exterior surfaces 68, 72, 74 meet with the outer cylindrical portion interior surfaces 76, 78, 82.

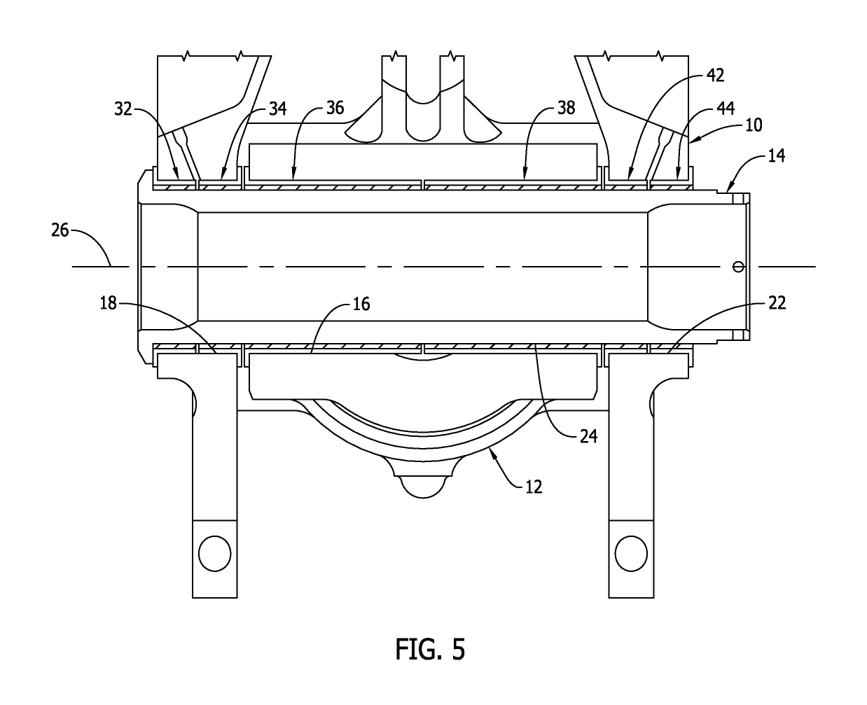

As represented in FIGS. 5 and 6, the inner cylindrical portions 46, 48, 52 and the outer cylindrical portions 54, 56, 58 have substantially the same radial thicknesses. In alternate embodiments the radial thicknesses of the inner cylindrical portions 46, 48, 52 could be different from those of the outer cylindrical portions 54, 56, 58.

As represented in FIGS. 5 and 6, the axial lengths of the inner cylindrical portions 46, 48, 52 and their respective outer cylindrical portions 54, 56, 58 are substantially the same. In alternate embodiments the axial lengths of the inner cylindrical portions 46, 48, 52 could be different from those of the outer cylindrical portions 54, 56, 58.

Each of the inner cylindrical portions 46, 48, 52 is constructed of a first material having a first thermal dissipating capacity. Each of the outer cylindrical portions 54, 56, 58 is constructed of a second material having a second thermal dissipating capacity. The first material of the inner cylindrical portions 46, 48, 52 has a lower coefficient of friction and better wear characteristics than the second material of the outer cylindrical portions 54, 56, 58. The first material of the inner cylindrical portions 46, 48, 52 is more thermally conductive than the second material of the outer cylindrical portions 54, 56, 58. Stated differently, the first material of the inner cylindrical portions 46, 48, 52 has more thermal dissipating capacity than the second material of the outer cylindrical portions 54, 56, 58, or the second material of the outer cylindrical portions 54, 56, 58 has less thermal dissipating capacity than the first material of the inner cylindrical portions 46, 48, 52. With the material of the inner cylindrical portions 46, 48, 52 of the bushings 32, 34, 36 being more thermally conductive, friction-induced heat created by the rotation of the bushings around the pivot pin exterior surface 24 is spread circumferentially through the inner cylindrical portions 46, 48, 52 of the bushings 32, 34, 36 before transferring radially to the respective outer cylindrical portions 54, 56, 58 of the bushings. This distributes the friction-induced heat more evenly through the bushings 32, 34, 36 and inhibits or prevents localized hot spots from forming on the truck beam bore cylindrical interior surface 16 and the inner cylinder fork cylindrical interior surface 18, thus inhibiting or preventing localized friction-induced heat damage to the truck beam 12 and the inner cylinder fork 10.

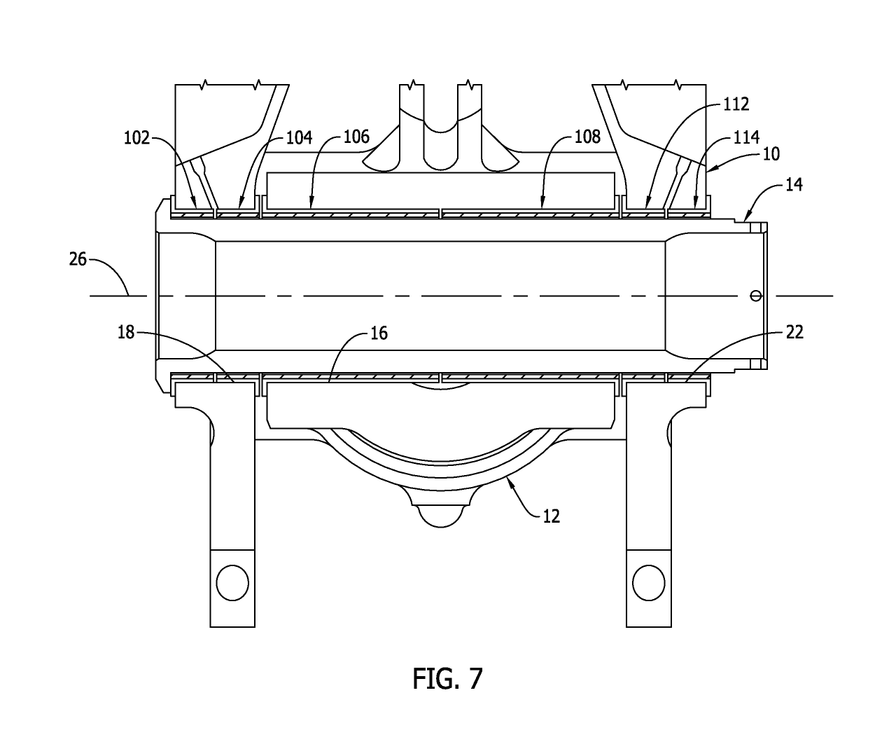

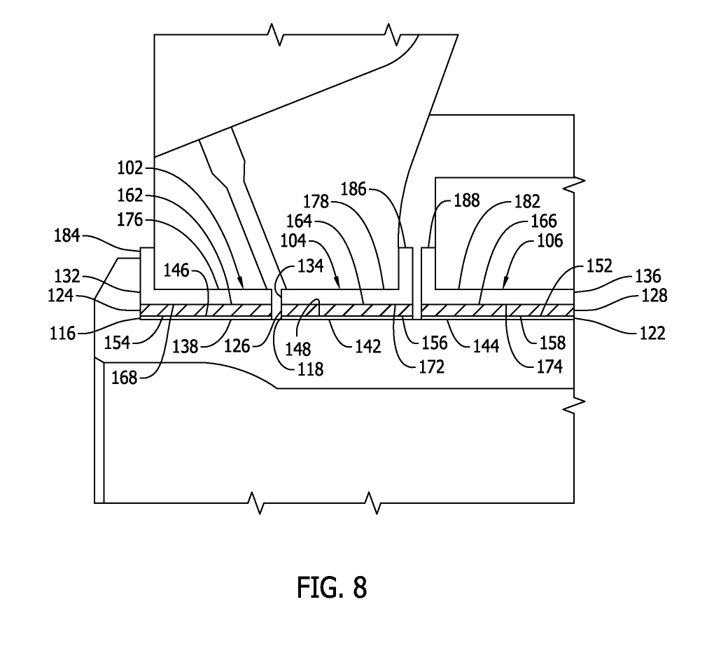

Represented in FIGS. 7 and 8 are cross-sections of six enhanced thermally conductive pivot bushings 102, 104, 106, 108, 112, 114 that are further embodiments of the pivot bushings represented in FIGS. 2 and 4. Two of the bushings 102, 104 are in contact with the pivot pin exterior surface 24 and positioned inside the cylindrical interior surface 18 of the left side fork arm shown in FIG. 7. Two of the bushings 106, 108 are in contact with the pivot pin exterior surface 24 and positioned inside the truck beam bore cylindrical interior surface 16. The remaining two bushings 112, 114 are in contact with the pivot pin exterior surface 24 and positioned inside the cylindrical interior surface 22 of the right side fork arm shown in FIG. 7. Because the constructions of each of the six enhanced thermally conductive bushings 102, 104, 106, 108, 112, 114 are substantially the same, and because the three bushings 102, 104, 106 to the left in FIG. 7 are mirror images of the three bushings 108, 112, 114 to the right in FIG. 7, only the constructions of the three bushings 102, 104, 106 to the left in FIG. 7 will be further described herein.

Referring to FIG. 8, each of the three bushings 102, 104, 106 is constructed with an inner cylindrical portion 116, 118, 122, a middle cylindrical portion 124, 126, 128 and an outer cylindrical portion 132, 134, 136. The inner cylindrical portions 116, 118, 122 have respective cylindrical interior surfaces 138, 142, 144 and opposite cylindrical exterior surfaces 146, 148, 152. The middle cylindrical portions 124, 126, 128 have respective cylindrical interior surfaces 154, 156, 158 and opposite cylindrical exterior surfaces 162, 164, 166. The middle cylindrical portion interior surfaces 154, 156, 158 engage around the respective inner cylindrical portion exterior surfaces 146, 148, 152. The outer cylindrical portions 132, 134, 136 have respective cylindrical interior surfaces 168, 172, 174 and opposite cylindrical exterior surfaces 176, 178, 182. The outer cylindrical portion interior surfaces 168, 172, 174 engage around the respective middle cylindrical portion exterior surfaces 162, 164, 166. The outer cylindrical portion exterior surfaces 176, 178 are press fit or shrunk fit inside the inner cylinder fork cylindrical interior surface 18. The outer cylindrical portion exterior surface 182 is press fit or shrunk fit inside the truck beam bore cylindrical interior surface 16. Each of the three bushings 102, 104, 106 has a respective annular flange 184, 186, 188 that extends radially outwardly from one axial end of the bushing outer cylindrical portion 132, 134, 136.

The inner cylindrical portions 116, 118, 122 and their respective middle cylindrical portions 124, 126, 128 and outer cylindrical portions 132, 134, 136 could be separate cylinders with the middle cylindrical portions 124, 126, 128 fit over the respective inner cylindrical portions 116, 118, 122 and the outer cylindrical portions 132, 134, 136 fit over the respective middle cylindrical portions 124, 126, 128. Alternatively, the inner cylindrical portions 116, 118, 122 and their respective middle cylindrical portions 124, 126, 128 and outer cylindrical portions 132, 134, 136 could be formed as monolithic cylinders with the materials of the concentric and coaxial cylinders being fused together where the inner cylindrical portion exterior surfaces 146, 148, 152 meet with the middle cylindrical portion interior surfaces 154, 156, 158 and the middle cylindrical portion exterior surfaces 162, 164, 166 meet with the outer cylindrical portion interior surfaces 168, 172, 174.

The inner cylindrical portions 116, 118, 122, the middle cylindrical portions 124, 126, 128 and the outer cylindrical portions 132, 134, 136 could have substantially the same radial thicknesses, or different radial thicknesses.

Additionally, the inner cylindrical portions 116, 118, 122, the middle cylindrical portions 124, 126, 128 and the outer cylindrical portions 132, 134, 136 could have the same axial lengths, or different axial lengths.

Each of the inner cylindrical portions 116, 118, 122 is constructed of a first material. Each of the middle cylindrical portions 124, 126, 128 is constructed of a second material. Each of the outer cylindrical portions 132, 134, 136 is constructed of a third material.

The first material is optimized for wear resistance and low friction coefficient. The first material has a greater wear resistance and a lower friction coefficient than the second material and the third material.

The second material is optimized for high thermal conductivity. The second material has a greater thermal conductivity than the first material and the third material.

The third material is optimized for low thermal conductivity. The third material has a lower thermal conductivity than the first material and the second material.

The second material of the middle cylindrical portions 124, 126, 128 has more thermal dissipating capacity than the first material of the inner cylindrical portions 116, 118, 122 and the third material of the outer cylindrical portions 132, 134, 136.

With the second material of the middle cylindrical portions 124, 126, 128 of the bushings 102, 104, 106 being more thermally conductive and having more thermal dissipating capacity than the first material of the inner cylindrical portions 116, 118, 122 and the third material of the outer cylindrical portions 132, 134, 136, friction induced heat created in the bushing inner cylindrical portions 116, 118, 122 is spread circumferentially around the bushings 102, 104, 106 through the respective middle cylindrical portions 124, 126, 128 before transferring radially to the respective outer cylindrical portions 132, 134, 136 of the bushings. This distributes the friction induced heat more evenly through the bushings 102, 104, 106 and inhibits or prevents localized hotspots from forming on the truck beam bore interior surface 16 and the inner cylinder fork cylindrical interior surface 18, thus inhibiting or preventing localized friction induced heat damage to the truck beam 12 and the inner cylinder fork 10.

As various modifications could be made in the construction of the apparatus and its method of operation herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

1. An aircraft pivot joint bushing comprising:
an inner cylindrical portion having a first thermal dissipating capacity;
an outer cylindrical portion on the inner cylindrical portion, the outer cylindrical portion having a second thermal dissipating capacity, the second thermal dissipating capacity being less than the first thermal dissipating capacity.

2. The bushing of claim 1, further comprising:
the inner cylindrical portion including a first material; and,
the outer cylindrical portion including a second material that is different from the first material.

3. The bushing of claim 2, further comprising:
the inner cylindrical portion having a cylindrical exterior surface; and,
the outer cylindrical portion having a cylindrical interior surface that engages the inner cylindrical portion's exterior surface.

4. The bushing of claim 2, further comprising:
the outer cylindrical portion being coaxial with the inner cylindrical portion.

5. The bushing of claim 2, further comprising:
a middle cylindrical portion including a third material, the middle cylindrical portion being between the inner cylindrical portion and the outer cylindrical portion, and the third material being different from the first material and the second material.

6. The bushing of claim 5, further comprising:
the bushing consisting of the inner cylindrical portion, the middle cylindrical portion and the outer cylindrical portion.

7. The bushing of claim 2, further comprising:
the bushing consisting of the inner cylindrical portion and the outer cylindrical portion.

8. The bushing of claim 2, further comprising:
the inner cylindrical portion being mounted inside the outer cylindrical portion; and,
the outer cylindrical portion being mounted in a truck beam or inner cylinder fork.

9. An aircraft pivot joint bushing comprising:
a first cylinder of a first material;
a second cylinder of a second material, the second cylinder surrounding the first cylinder; and,
the first material being more thermally conductive than the second material.

10. The bushing of claim 9, further comprising:
the first and second materials being different materials.

11. The bushing of claim 10, further comprising:
the first cylinder having a cylindrical exterior surface; and,
the second cylinder having a cylindrical interior surface that engages the first cylinder exterior surface.

12. The bushing of claim 10, further comprising:
the second cylinder being coaxial with the first cylinder.

13. The bushing of claim 9, further comprising:
a third cylinder of a third material; and,
the first cylinder surrounding the third cylinder.

14. The bushing of claim 13, further comprising:
the bearing consisting of the first, second and third cylinders.

15. The bushing of claim 10, further comprising:
the bushing consisting of the first cylinder and second cylinder.

16. The bushing of claim 10, further comprising:
the first cylinder being mounted inside the second cylindrical portion; and,
the second cylinder being mounted in a truck beam or inner cylinder fork.

17. A method of enhancing thermal conductivity of an aircraft pivot joint bushing comprising:
constructing the bushing with an inner cylindrical portion having a first thermal conductivity;
constructing the bushing with an outer cylindrical portion on the inner cylindrical portion with the outer cylindrical portion having a second thermal conductivity, the second thermal conductivity being less than the first thermal conductivity.

18. The method of claim 17, further comprising:
constructing the inner cylindrical portion including a first material; and,
constructing the outer cylindrical portion including a second material that is different from the first material.

19. The method of claim 18, further comprising:
constructing the inner cylindrical portion with a cylindrical exterior surface;
constructing the outer cylindrical portion with a cylindrical interior surface; and,
engaging the outer cylindrical portion interior surface on the inner cylindrical portion exterior surface.

20. The method claim 18, further comprising:
mounting the inner cylindrical portion inside the outer cylindrical portion; and,
mounting the outer cylindrical portion in a truck beam or inner cylinder fork.
